(19) United States
(12) Patent Application Publication
(10) Pub. No.: US 2009/0320633 A1
(43) Pub. Date: Dec. 31, 2009

(54) SELECTOR LEVER DEVICE FOR A VEHICLE TRANSMISSION

(75) Inventor: Peter Knysch, Senden (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/475,996

(22) Filed: Jun. 1, 2009

(30) Foreign Application Priority Data
Jun. 24, 2008 (DE) 102008029890.5-14

(51) Int. Cl. F16H 59/04; G06F 19/00

(52) U.S. Cl. 74/473.3; 701/51

(57) ABSTRACT

A selector lever device for a transmission of a motor vehicle has a selector lever which, for the selection of gears, is arranged in or on a housing so as to be adjustable between predetermined shift positions. A sensor arrangement determines a position of the selector lever relative to the housing, with the sensor arrangement having a magnetic field generator which is coupled in terms of movement to the selector lever and which, by an adjustment of the selector lever for the selection of a gear, can be adjusted along a movement path. A high level of reliability is obtained if the sensor arrangement has a plurality of magnetic field sensors distributed along the movement path such that each predetermined shift position is assigned at least two magnetic field sensors which are actuated by the magnetic field generator when the selector lever is situated in the associated shift position.

### CROSS-REFERENCE TO RELATED APPLICATION

This application claims the priority, under 35 U.S.C. § 119, of German application DE 10 2008 029 890.5-14, filed Jun. 24, 2008; the prior application is herewith incorporated by reference in its entirety.

### BACKGROUND OF THE INVENTION

### Field of the Invention

The present invention relates to a selector lever device for a transmission of a motor vehicle, in particular of a passenger motor vehicle.

A selector lever device of this type may be fitted with a selector level which, for the selection of gears or gear stages of the transmission, is arranged in or on a housing of the selector lever device so as to be adjustable between predetermined shift positions. Furthermore, the selector lever device may be fitted with a sensor arrangement for determining a present position of the selector lever relative to the housing. In this way, signals can be generated by the selector lever device or by a control unit of the selector lever device, which signals correlate with the present shift position of the selector lever. By signals of this type, it is possible for a display which represents the present shift position of the selector lever to be visualized, for example, on a corresponding display device in the cockpit of the vehicle. Furthermore, by signals of this type, it is possible to transmit to a transmission control unit the present shift demand of the vehicle driver, as expressed by the selected shift position of the selector lever, in order that the transmission control unit can operate the transmission correspondingly. A selector lever device of this type is suitable in particular for use in a shift-by-wire system which transmits the shift commands of the selector lever device to the transmission, or to the control unit thereof, not mechanically but rather via corresponding signal lines or data lines.

In particular, in X-by-wire applications of this type, such as shift-by-wire, steer-by-wire and brake-by-wire, there is a demand for the greatest possible level of reliability and safety against failure.

### SUMMARY OF THE INVENTION

It is accordingly an object of the invention to provide a selector lever device for a vehicle transmission that overcomes the above-mentioned disadvantages of the prior art devices of this general type, which embodiment is characterized in particular in that it has a relatively high level of safety against failure and a correspondingly high level of reliability.

With the foregoing and other objects in view there is provided, in accordance with the invention, a selector lever device for an automatic transmission of a motor vehicle including a passenger motor vehicle. The selector lever device contains a housing; a selector lever which, for the selection of gears or gear stages, is disposed in or on the housing so as to be adjustable between predetermined shift positions; and a sensor configuration for determining a present position of the selector lever relative to the housing. The sensor configuration has a magnetic field generator coupled in terms of movement to the selector lever and which, by an adjustment of the selector lever for a selection of a gear or a gear stage, can be adjusted along a movement path. The sensor configuration further has a plurality of magnetic field sensors disposed so as to be distributed along the movement path of the magnetic field generator such that each of the predetermined shift positions of the selector lever is assigned at least two of the magnetic field sensors which are actuated by the magnetic field generator when the selector lever is situated in a respectively associated shift position.

The invention is based on the general concept of fitting the sensor arrangement with a magnetic field generator and with a plurality of magnetic field sensors, thereby permitting non-contact actuation and therefore wear-free actuation of the sensor arrangement. Here, the magnetic field generator is coupled in terms of movement to the selector lever and, by an adjustment of the selector lever, that is to say during the selection of a gear or of a gear stage, can be adjusted along a predetermined movement path. The magnetic field sensors are now arranged so as to be distributed along the movement path of the magnetic field generator, specifically in such a way that each predetermined shift position of the selector lever is assigned at least two magnetic field sensors. Consequently, the magnetic field generator can actuate the at least two magnetic field sensors simultaneously when the selector lever is situated in one of the predetermined shift positions. In this way, a redundant signal is generated for each shift position, which increases the reliability of the sensor arrangement and therefore of the selector lever device. Furthermore, the redundant arrangement or assignment of the magnetic field sensors provides increased safety against failure of the selector lever device, since in the event of a failure of one magnetic field sensor in the respective shift position, the at least one remaining magnetic field sensor is sufficient to generate a clear signal which correlates with the present shift position of the selector lever.

According to one advantageous embodiment, at least one of the magnetic field sensors may be assigned two adjacent shift positions, with an evaluation logic unit then detecting which shift position the selector lever is in on the basis of the respective combination of actuated magnetic field sensors. The configuration is based on the knowledge that, to create an effective redundancy, it is possible for individual magnetic field sensors to perform a dual function, or in other words, the respective magnetic field sensor is actuated in two adjacent shift positions. By combinatorial analysis, it is possible for an evaluation logic unit to clearly identify which shift position is present as a function of the other actuated and non-actuated magnetic field sensors. In particular, the dual-function magnetic field sensor may be a “third” magnetic field sensor, such that the one or the other shift position is assigned three magnetic field sensors which can be actuated simultaneously by the magnetic field generator when the selector lever is in the associated shift position. In this way, it is possible to create a further redundancy which increases the safety against failure and the reliability of the selector lever device.

An embodiment is particularly expedient in which the selector lever device is configured to actuate an automatic transmission and, for this purpose, has a shift slot with an automatic lane for conventional automatic gear stages and also a manual lane for conventional manual shift positions. In particular, the magnetic field device may then be coupled to the selector lever in such a way that the magnetic field generator is always adjusted along the same movement path regardless of whether the selector lever is adjusted or arranged in the automatic lane or in the manual lane. By this configuration, the magnetic field sensors which are arranged along the movement path may be used both to detect the automatic gear stages and also to detect the manual shift stages. As a result of this dual functionality of the magnetic field sensors and also of the magnetic field generator, it is possible to obtain a high level of reliability for the selector lever device for the two operating modes “automatic” and “manual” in a comparatively cheap manner.

It is self-evident that the features specified above and the features yet to be explained below can be used not only in the respectively specified combination but rather also in other combinations or individually without departing from the scope of the present invention.

Preferred exemplary embodiments of the invention are illustrated in the drawings and are explained in more detail in the following description, with the same reference symbols being used to denote identical or similar or functionally identical components.

Other features which are considered as characteristic for the invention are set forth in the appended claims.

Although the invention is illustrated and described herein as embodied in a selector lever device for a vehicle transmission, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a simplified diagrammatic illustration, in a form of a circuit diagram, of a selector lever device according to the invention;

FIG. 2 is a schematic plan view of a shift slot of the selector lever device;

FIG. 3 is a detailed view of a detail, denoted in FIG. 1 by III, in an automatic mode; and

FIG. 4 shows a view as in FIG. 3, but in a manual mode.

### DETAILED DESCRIPTION OF THE INVENTION

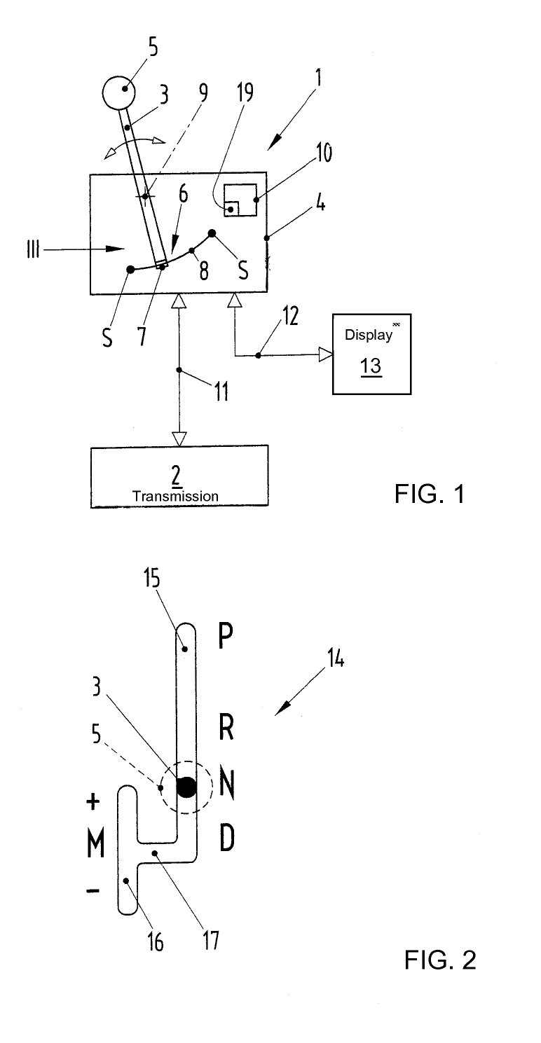

Referring now to the figures of the drawing in detail and first, particularly, to FIG. 1 thereof, there is shown a selector lever device 1, by which a transmission 2 of a non-illustrated motor vehicle, in particular of a passenger motor vehicle, can be actuated, contains a selector lever 3 and a housing 4. The selector lever 3 is arranged in an adjustable fashion on or in the housing 4, with the selector lever 3 being adjustable between a plurality of predetermined shift positions. Here, the selector lever 3 serves for the selection of gears or gear stages of a transmission 2, and for this purpose, can be adjusted into the predetermined shift positions. The selection of a gear or of a gear stage takes place by the adjustment of the selector lever 3 into the respectively associated shift position. The selector lever 3 may be provided with a handle 5.

Furthermore, the selector lever device 1 is fitted with a sensor arrangement 6, by which the present position of the selector lever 3 relative to the housing 4, or the present shift position of the selector lever 3, can be determined. For this purpose, the sensor arrangement 6 has a magnetic field generator 7. The latter is coupled in terms of movement to the selector lever 3, specifically in such a way that an adjusting movement of the selector lever 3 positively leads to a correlating adjusting movement of the magnetic field generator 7. Here, the selector lever 3 and magnetic field generator 7 are coordinated with one another, or coupled to one another, in such a way that the magnetic field generator 7, by an adjustment of the selector lever 3 for the selection of a gear or of a gear stage, can be adjusted along a movement path 8. Here, the selector lever 3 pivots, for example, about a pivot axis 9 with respect to which the selector lever 3 is mounted on the housing 4. The magnetic field generator 7 may now be arranged on the selector lever 3 or on a component which is driven by the selector lever 3, specifically in such a way that the movement path 8 runs in the shape of a circular arc with respect to the pivot axis 9.

Furthermore, the sensor arrangement 6 has a plurality of magnetic field sensors S, of which only two are illustrated in FIG. 1, purely by way of example. The magnetic field sensors S detect the proximity of the magnetic field generator 7 and generate a corresponding signal when the magnetic field generator 7 is in close proximity. In other words, the magnetic field generator 7, by moving into a position, which is assigned to a magnetic field sensor S, along the movement path 8, can actuate the respective magnetic field sensor S in a non-contact fashion such that the magnetic field sensor S generates a corresponding signal.

The selector lever device 1 expediently has a selector lever control unit 10 which interacts in a suitable way with the sensor arrangement 6. In particular, the magnetic field sensors S, when actuated, transmit corresponding signals to the selector lever control unit 10.

The control unit 10 can determine the present shift position of the selector lever 3 as a function of the actuated magnetic field sensors S in order to transmit the shift position, for example corresponding to a double arrow 11, to the transmission 2 or to a transmission control unit (not illustrated in any more detail). The selector lever control unit 10 may additionally or alternatively transmit the determined shift positions of the selector lever 3, corresponding to a double arrow 12, to a display device 13 or to a non-illustrated associated instrument control unit. The display device 13 may expediently be arranged in a cockpit of the vehicle which is fitted with the transmission 2 or with the selector lever device 1. The display device 13 may for example be integrated in a dashboard of the vehicle. In any case, the display device 13 can illustrate or visualize the present shift position of the selector lever 3 to the vehicle driver.

The selector lever device 1 may in particular be used in a shift-by-wire system. The selector lever device 1 is preferably used in connection with an automatic transmission 2. Accordingly, the selector lever device 1 is expediently configured to actuate an automatic transmission 2. For this purpose, a shift slot 14, which is illustrated in simplified form in FIG. 2, may be provided on the housing 4, in which shift slot 14 the selector lever 3 is arranged in an adjustable fashion. In the embodiment shown here, the shift slot 14 has an automatic lane 15 for the selection of automatic gear stages and a manual lane 16 for the selection of manual gear stages. The two shift lanes 15, 16 are connected to one another by a transverse lane 17. Here, the two shift lanes 15, 16 are aligned in a unidirectional fashion and are expediently arranged parallel to one another. Here, the automatic gear stages which can be set or selected in the automatic lane 15 are, purely by way of example, a park stage P, a reverse stage R, a neutral stage N and a forward stage D. Here, the manual shift positions of the manual lane 16 are, purely by way of example, a central position M, an upshift position + and a downshift position −. The functions of the automatic gear stages P, R, N and D are generally known and therefore need not be explained in any more detail. Only the functions of the manual shift positions should be briefly explained. In the upshift position +, the transmission 2 is activated so as to engage the in each case next highest gear, while in the downshift position −, the transmission 2 is activated so as to engage the in each case next lowest gear. The upshift position + and the downshift position − can be reached counter to a restoring spring force, against which the selector lever 3 must be pushed by the vehicle driver. The restoring forces drive the selector lever 3 within the manual lane 16 into the central position M at all times, which central position M represents a stable shift position.

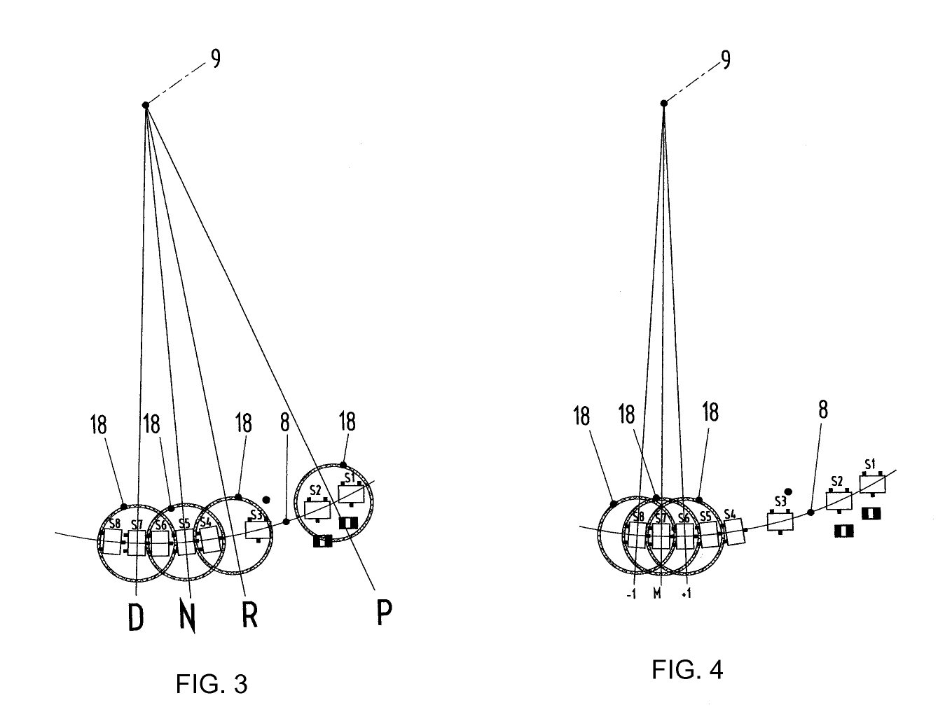

Corresponding to FIGS. 3 and 4, a total of eight magnetic field sensors S are arranged so as to be distributed along the movement path 8. In detail, according to FIG. 3, the park stage P is assigned a first magnetic field sensor S1 and a second magnetic field sensor S2. The reverse stage R is assigned a third magnetic field sensor S3 and a fourth magnetic field sensor S4. The neutral stage N is assigned the fourth magnetic field sensor S4, a fifth magnetic field sensor S5 and a sixth magnetic field sensor S6. The forward stage D is assigned the sixth magnetic field sensor S6, a seventh magnetic field sensor S7 and an eighth magnetic field sensor S8. In this connection, the term “assignment” means that, when the magnetic field generator 7 which is merely symbolized in FIGS. 3 and 4 by its sphere of activity 18 is in a position, which is assigned to the respective shift position of the selector lever 3, along the movement path 8, the magnetic field generator 7 actuates the magnetic field sensors S which are assigned to the shift position. Therefore, in the park stage P, the magnetic field generator 7 actuates the magnetic field sensors S1 and S2. This is visualized in that the two magnetic field sensors S1, S2 are situated within the sphere of activity 18 of the magnetic field generator 7. In the reverse stage R, the magnetic field sensors S3 and S4 are situated within the sphere of activity 18. In the neutral position N, the magnetic field sensors S4, S5 and S6 are situated within the sphere of activity 18, and in the forward stage D, the magnetic field sensors S6, S7 and S8 are situated within the sphere of activity 18.

With the selected distribution of the magnetic field sensors S along the movement path 8, each shift position of the automatic lane 15 is assigned in each case at least two magnetic field sensors S. In this way, it is possible to generate a desired redundancy for the signals which correlate with the shift position of the selector lever 3. While the park stage P and the reverse stage R are assigned in each case precisely two magnetic field sensors S, the forward stage D and the neutral stage N are assigned in each case three magnetic field sensors S. It may be particularly significant here that individual magnetic field sensors S can be assigned simultaneously to two different shift positions. The sixth magnetic field sensor S6 is thus assigned first to the forward stage D and second to the neutral stage N. The fourth magnetic field sensor S4 is also assigned first to the neutral stage N and second to the reverse stage R. The redundancy of the system can be realized in a relatively cheap manner by the multiple utilization of the magnetic field sensors S. The assignment of three magnetic field sensors S to a single shift position increases the reliability of the shift position and may also be utilized for additional functionalities.

As can be seen with reference to FIG. 2, the transverse lane 17 connects the two shift lanes 15 and 16 in such a way as to connect the forward stage D of the automatic lane 15 to the central position M of the manual lane 16. A refinement of the selector lever 1 or of the sensor arrangement 6 is now particularly advantageous in which the magnetic field generator 7 is coupled in terms of movement to the selector lever 3 in such a way that, during an adjustment of the selector lever 3 in the automatic lane 15 as per FIG. 3 and also during an adjustment of the selector lever 3 in the manual lane 16 as per FIG. 4, the magnetic field generator 7 interacts with the same magnetic field sensors S, that is to say in particular is adjusted along the same movement path 8. As a result of the possibility of using the sensor arrangement 6 both for the automatic lane 15 and also for the manual lane 16, the sensor arrangement 6 can be realized in a comparatively cheap manner.

As a result of the coupling of the forward stage D to the central position M, the forward stage D and the central position M are assigned the same magnetic field sensors S, specifically the sixth, seventh and eighth magnetic field sensors S6, S7 and S8. In FIG. 4, the downshift position − or −1 is illustrated adjacent to the central position M to the left. The downshift position − or −1 is assigned the seventh and eighth magnetic field sensors S7 and S8. The upshift position + or +1 is illustrated adjacent to the central position M to the right. The upshift position + or +1 is assigned the sixth and seventh magnetic field sensors S6 and S7. Furthermore, here, the upshift position + or +1 is assigned a further magnetic field sensor S, specifically the fifth magnetic field sensor S5.

As a result of the multi-functionality of individual sensors S realized here, and as a result of the assignment of a plurality of sensors S to in each case one shift position of the selector lever 3 or to in each case one position, which correlates with the selector lever position, of the magnetic field generator 7 along the movement path 8, it is possible in connection with a corresponding evaluation logic unit 19, which is indicated in FIG. 1 as a constituent part of the selector lever control unit 10, to realize an efficient redundancy for the position determination of the selector lever 3, with comparatively few sensors S being required at the same time.

The magnetic field sensors S may for example be embodied as Hall sensors. The magnetic field generator 7 is expediently a permanent magnet. An electromagnet is fundamentally also conceivable.

The magnetic field generator 7 has a measurable, spatially bounded sphere of activity 18. The distribution of the magnetic field sensors S and the arrangement of the movement path 8, that is to say in particular the spacing of the movement path 8 from the pivot axis 9, are expediently selected as a function of the spatial dimension of the sphere of activity 18. The coordination is preferably carried out in a targeted fashion such that it is always possible to clearly assign, or make a clear distinction between, the states of “magnetic field sensor actuated” and “magnetic field sensor not actuated”.

The sensor arrangement 6 may in particular have at least one further sensor or switch (not illustrated here), by which the sensor arrangement 6 can determine whether the selector lever 3 is situated in the automatic lane 15 or in the manual lane 16. In particular, it may be sufficient to detect merely a change between the lanes 15, 16.

1. A selector lever device for an automatic transmission of a motor vehicle including a passenger motor vehicle, the selector lever device comprising:
a housing;
a selector lever which, for the selection of gears or gear stages, is disposed one of in and on said housing so as to be adjustable between predetermined shift positions; and
a sensor configuration for determining a present position of said selector lever relative to said housing, said sensor configuration having a magnetic field generator coupled in terms of movement to said selector lever and which, by means of an adjustment of said selector lever for a selection of a gear or a gear stage, can be adjusted along a movement path, said sensor configuration further having a plurality of magnetic field sensors disposed so as to be distributed along said movement path of said magnetic field generator such that each of the predetermined shift positions of said selector lever is assigned at least two of said magnetic field sensors which are actuated by said magnetic field generator when said selector lever is situated in a respectively associated shift position.

2. The selector lever device according to claim 1,
wherein at least one of said magnetic field sensors is assigned two adjacent shift positions; and
further comprising an evaluation logic unit detecting which of the predetermined shift positions said selector lever is in on a basis of a respective combination of actuated ones of said magnetic field sensors.

3. The selector lever device according to claim 1, wherein at least one of the predetermined shift positions is assigned said magnetic field sensors which are actuated by said magnetic field generator when said selector lever is situated in the respectively associated shift position.

4. The selector lever device according to claim 1, wherein said selector lever device is configured to actuate the automatic transmission.

5. The selector lever device according to claim 1, wherein said housing has a shift slot formed therein, said selector lever is disposed in an adjustable fashion in said shift slot, said shift slot has an automatic lane for a selection of the gear stages including at least a park stage, a reverse stage, a neutral stage and a forward stage.

6. The shift device according to claim 5, wherein said shift slot further has a manual lane for the selection of manual shift positions including at least a central position, an upshift position and a downshift position.

7. The selector lever device according to claim 6, wherein said magnetic field generator is coupled in terms of movement to said selector lever such that, during an adjustment of said selector lever in said automatic lane and in said manual lane, said magnetic field generator is adjusted along said movement path.

8. The selector lever device according to claim 7, wherein said shift slot has a transverse lane for changing between said automatic lane and said manual lane, said transverse lane connecting said forward stage to said central position, such that said magnetic field sensors which are assigned to said forward stage are also assigned to said central position.

9. The selector lever device according to claim 6, wherein said central position is assigned three of said magnetic field sensors, specifically a central magnetic field sensor and a magnetic field sensor which is adjacent in a direction of the downshift position and a magnetic field sensor which is adjacent in a direction of the upshift position, wherein in the downshift position, said magnetic field generator actuates, of said three magnetic field sensors, only said central magnetic field sensor and said magnetic field sensor which is adjacent in the direction of the upshift position, and in the upshift position, said magnetic field generator actuates, of said three magnetic field sensors, only said central magnetic field sensor and said magnetic field sensor which is adjacent in the direction of the upshift position.

10. The selector lever device according to claim 9, wherein the upshift position is assigned a further one of said magnetic field sensors, such that the upshift position is also assigned three of said magnetic field sensors.

11. The selector lever device according to claim 5, wherein:
the park stage is assigned a first magnetic field sensor and a second magnetic field sensor of said magnetic field sensors;
the reverse stage is assigned a third magnetic field sensor and a fourth magnetic field sensor of said magnetic field sensors;
the neutral stage is assigned said fourth magnetic field sensor, a fifth magnetic field sensor and a sixth magnetic field sensor of said magnetic field sensors; and
the forward stage is assigned said sixth magnetic field sensor, a seventh magnetic field sensor and an eighth magnetic field sensor of said magnetic field sensors.

12. The selector lever device according to claim 11, wherein:
the central position is assigned said sixth magnetic field sensor, said seventh magnetic field sensor and said eighth magnetic field sensor;
the downshift position is assigned said seventh magnetic field sensor and said eighth magnetic field sensor; and
the upshift position is assigned said sixth magnetic field sensor and said seventh magnetic field sensor.

13. The selector lever device according claim 1, wherein:
said magnetic field sensors are Hall sensors;
said magnetic field generator is one of an electromagnet and a permanent magnet; and
said magnetic field sensors are positioned along said movement path in dependence on a spatial dimension of a sphere of activity of said magnetic field generator.

14. The selector lever device according to claim 1, wherein said selector lever device is formed as a constituent part of a shift-by-wire system.

15. The selector lever device according to claim 12, wherein the upshift position is further assigned said fifth magnetic field sensor.
